(19) United States
(12) Patent Application Publication
(10) Pub. No.: US 2013/0061864 A1
(43) Pub. Date: Mar. 14, 2013

(54) DENTAL FLOSSING DEVICE AND FLOSSING METHOD

(71) Applicant: Teppo Örmä, Helsinki (FI)

(72) Inventor: Teppo Örmä, Helsinki (FI)

(73) Assignee: HELMIKAIVOS OY, Helsinki (FI)

(21) Appl. No.: 13/642,035

(22) PCT Filed: May 3, 2011
(86) PCT No.: PCT/FI2011/050405

§ 371 Date: Nov. 27, 2012

(30) Foreign Application Priority Data
May 12, 2010 (FI) 20105521

(51) Int. Cl. A61C 15/04

(52) U.S. Cl. 132/200; 132/323

(57) ABSTRACT

The present invention provides a novel dental flossing device (1), which is adapted to be inserted entirely into an oral cavity of the user. The flossing device (1) comprises a floss string (10) and at least two manipulation members (21), which are connected by the string (10) for control thereof. The manipulation members (21) are adapted to be guided by oral muscles, particularly the tongue, of the user, whereby the floss string (10) may be guided by tongue via the manipulation members (21) without introducing fingers to said oral cavity.

The present invention relates to personal hygiene. In particular, the present invention relates to oral hygiene. More specifically, the invention relates to a dental flossing device and flossing method according to the preamble portions of claims 1 and 15.

As important part of personal hygiene, good oral hygiene involves cleaning not only the teeth but also the tongue and gums. In addition to frequent brushing of teeth and cleaning of tongue, experts recommend flossing at least once a day. Flossing is typically performed with a thin nylon, Teflon or polyethylene ribbon to remove and dispose of food residues and plaque from between adjacent teeth as well as from between teeth and gums. Standard dental floss is sold in dispensing containers, from which the user cuts a piece of floss, which is wound around two fingers. The floss is then guided with said fingers in reciprocating motion between the teeth and under the gum line to remove particles of food stuck between teeth and dento-bacterial plaque.

However, flossing has been considered burdensome because of the task of operating the dispenser and guiding the floss. Because the floss is guided within the mouth with fingers, the method exposes the oral cavity to impurities of the user's hands. Disposable floss picks have therefore been introduced to hold the floss tightened between two prongs protruding from a handle. Disposable floss picks may not be used more than once, whereby various other assisting devices have been introduced to tackle this problem.

U.S. Pat. No. 5,454,386 A discloses a dental floss device having two ring portions, in between which a floss portion is provided, whereby the ring portions are placed on the user's fingers. The ring portions help the user in keeping the floss portion suitably tightened without the traditional need for entwining the floss portion directly around fingertips. The floss portion is detachably attached to the ring portions with a special fixing mechanism, whereby the floss portion is changeable. However, this approach still requires using said fingers to guide the floss portion within the mouth, which is not hygienically desirable. Furthermore the approach is not especially suitable for public use since the traditional flossing motion is considered rather inelegant.

The aim of the invention is therefore to provide an improved dental flossing device and to mitigate at least some of the disadvantages of the prior art.

It is a particular aim to provide a dental flossing device, which is easy to use frequently and also publically without using hands or fingers to guide the floss between the teeth.

The aim of the invention is achieved with a novel dental flossing device, which is adapted to be inserted entirely into an oral cavity of the user. The flossing device comprises a floss string and at least two manipulation members, which are connected by the floss string 10 for control thereof. The manipulation members are adapted to be guided by oral muscles, particularly the tongue, of the user, whereby the floss string may be guided by tongue via the manipulation members without introducing fingers to said oral cavity.

More specifically the dental flossing device according to the invention is characterized by what is stated in the characterizing portion of claim 1.

According to another aspect of the invention, the flossing device comprises a floss string and at least two spherical manipulation members attached thereto and forming a finite band. Further according to the aspect, the manipulation members have a diameter of 6 to 12 mm and the floss string has a span length of 15 to 25 mm there between.

Considerable benefits are gained with aid of the present invention.

The novel dental flossing device can be guided by the user's oral muscles, particularly the tongue, which has hygienic advantages as there is no need to insert fingers to the oral cavity. The device can be stored in antiseptic packaging, from which the device may be inserted directly into the oral cavity, whereby the device is not subject to impurities of the user's hands. The floss string is also easy to guide and flossing can be performed esthetically in public places since fingers are not involved. The user-friendliness of the flossing method established by the novel device leads to more frequent flossing and better oral hygiene.

As a further benefit the device is rather small and therefore suitable for the user to carry with him. The manipulation members can be easily made to different shapes, whereby they can be designed to represent a company logo or a fictive character for appealing to younger users. The device can be packed into single-serving packages or they can be handed out from a bowl in a restaurant, for example.

According to one embodiment of the invention, the device is manufactured from a decomposing material, for example a natural fiber composite, such as polylactide (PLA), which is not harmful when swallowed. When made from easily digestive materials, the device can be disposed of without generating waste. According to one further alternative or additional embodiment, the device is manufactured from a decomposing material, whereby the device may be disposed of by composting.

In the following, certain embodiments of the invention are described with reference to the accompanying drawings, in which:

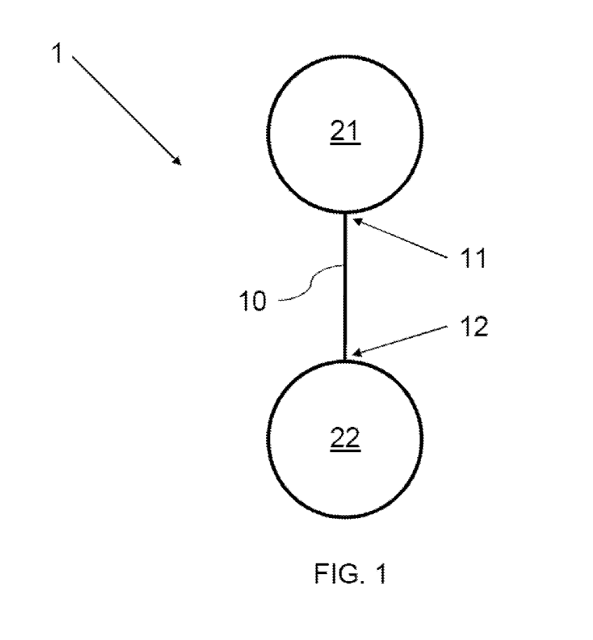

FIG. 1 presents a dental flossing device according to one embodiment of the invention,

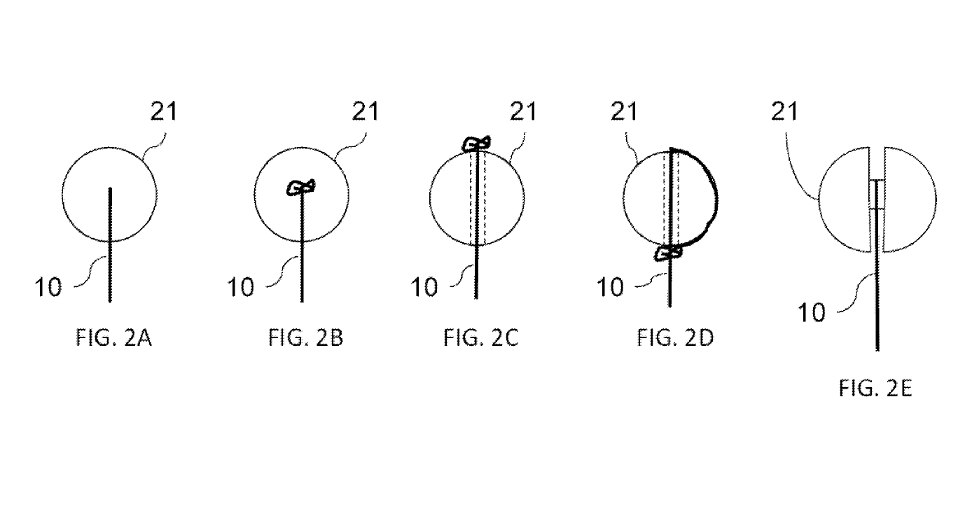

FIGS. 2A to 2E present various attachments between the floss string and the manipulation member,

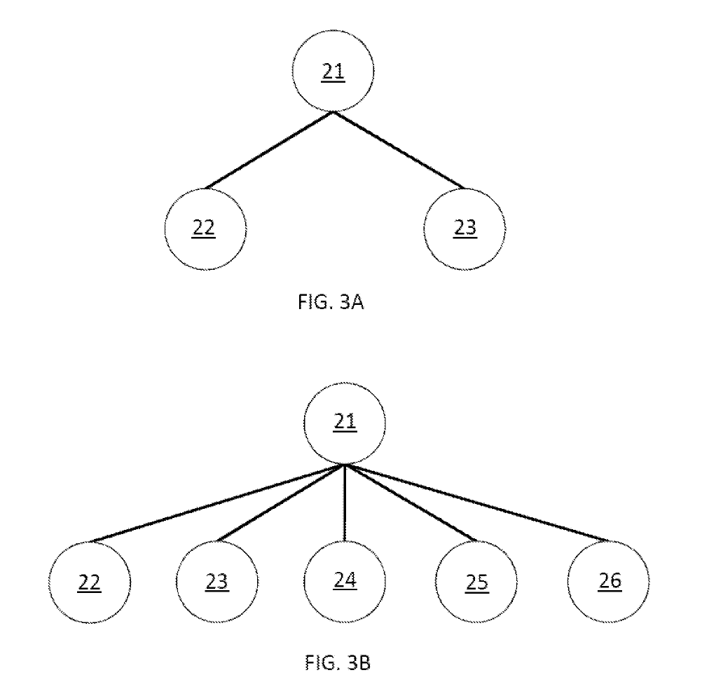

FIG. 3A presents a net layout having three manipulation members according to one embodiment,

FIG. 3B presents a net layout having six manipulation members according to another embodiment,

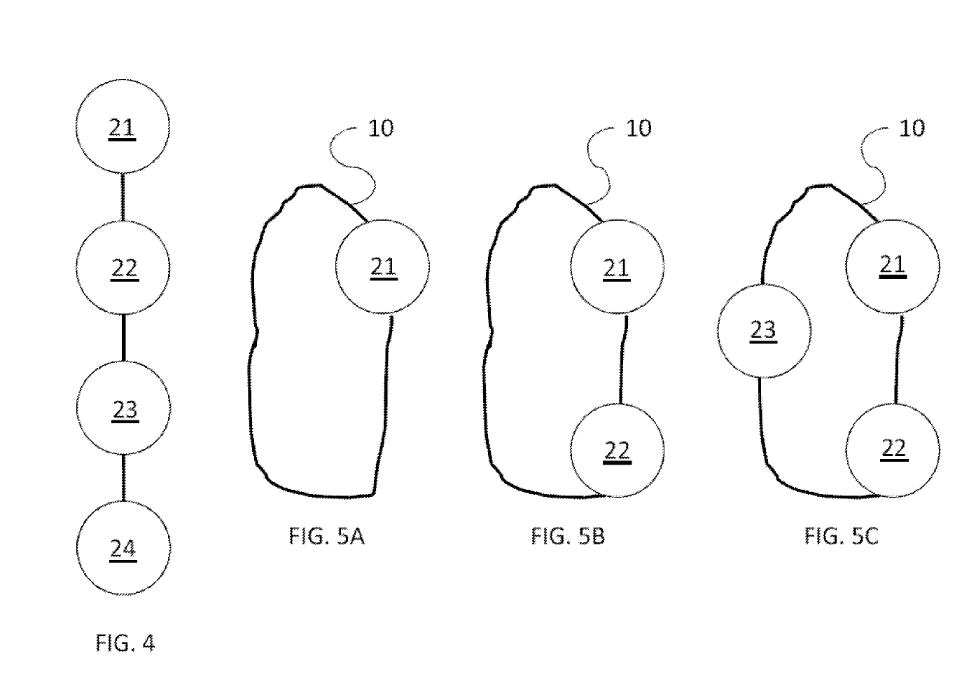

FIG. 4 presents a string layout having four manipulation members according to one embodiment, and

FIGS. 5A to 5C present a loop design having one to three manipulation members, respectively, according to three embodiments of the invention.

According to a simple embodiment illustrated in FIG. 1, the flossing device 1 comprises two spherical manipulation members 21, 22 attached to opposite ends 11, 12 of a floss string 10. The manipulation members 21, 22 are dimensioned so that they can be inserted completely into the oral cavity of the user and such that they can be moved around the mouth by using only the tongue. Accordingly, the members 21, 22 must be small enough to fit between the teeth or gums and inner surface of the lip or cheek. On the other hand the members 21, 22 must be large enough to be easily located and moved with the tongue. A suitable diameter for a spherical manipulation member 21, 22 is about 3 to 25 mm, preferably 6 to 12 mm. Naturally, different sizes may be provided for different user preferences. Furthermore, the manipulation member 21, 22 may also have another shape, such as a rounded polyhedron, cone, hemisphere, heart, cylinder, prolate spheroid, etc.

The floss string 10 has a span length between the members 21, 22 of about 5 to 60 mm, preferably about 10 to 50 mm, most preferably about 15 to 25 mm. The floss string 10 is preferably of standard floss string material, such as polymer compounds, which are known per se.

The manipulation members 21, 22 may be manufactured from a variety of materials. According to a preferable embodiment, the members 21, 22 are manufactured from a decomposing material, such as natural fiber composite, polylactide (PLA), cornstarch wheat starch etc., which is not harmful when swallowed. Preferable the device 1 is made from easily digestive materials. Alternatively or additionally the device is manufactured from a decomposing material, whereby the device may be disposed of by composting.

The members 21, 22 may also be made of other materials such as, plastic, gum (rubber), leather etc.

According to one embodiment the manipulation members 21, 22 include special substances to improve the hygienic, odontological or pharmaceutical effect or user-friendliness of the device 1. For example, the manipulation members 21, 22 can be provided, such as coated or impregnated, with fluorine or xylitol for protecting the teeth chemically from acid attacks. Alternatively or additionally, the members 21, 22 may be provided with different flavors, such as eucalyptus, mint, peppermint, strawberry, etc., for making the experience as pleasant as possible. Furthermore, nicotine and/or caffeine could be used as pharmaceutically active components. Similar substances can also be applied to the floss string 10.

As illustrated in FIGS. 2A to 2E, the floss string 10 can attached to the manipulation member 21 in a variety of different attachment constructions. According to one embodiment (FIG. 2A), the terminal end of the floss string 10 is pressed into the spherical member 21 during forming thereof, particularly during pressing or injection molding. According to another embodiment, the terminal end of the floss string 10 is arranged into a knot for improving attachment (FIG. 2B). Alternatively, the manipulation member 21 can be provided with an assisting profile to cater for the attachment. According to one embodiment, the member 21 is provided with a hole, through which the floss string 10 runs being anchored to the outer (FIG. 2C) or inner (FIG. 2D) periphery of the member 21. According to another embodiment, the spherical manipulation member 21 is provided with a central annular groove and the floss string 10 attached to the inner core of the member 21. It is considered obvious for a skilled person to construct further variants to the attachment arrangement without departing from the scope of the present inventive concept.

As discussed above, the dental floss device 1 according to the present invention comprises at least one manipulation member 21. Concurrent to the embodiment of FIG. 1 comprising two sequentially arranged manipulation members 21, 22, the inventive dental floss device 1 may be constructed with a plurality of different manipulation member layouts. According to the embodiment illustrated in FIG. 3A, the dental floss device 1 comprises three manipulation members 21, 22, 23 arranged in a net layout, wherein the first manipulation member 21 is attached to a second manipulation members 22 and third manipulation member 23 parallel thereto. According to another embodiment, the device 1 comprises six manipulation members 21 . . . 26 arranged in a net layout, wherein first manipulation member 21 is attached to five parallel manipulation members 22 . . . 26 (FIG. 3B). Other net layout constructions are also possible.

According to one embodiment, the manipulation members are different from one another for creating a combination of a plurality of desired effects. For example, the first manipulation member 21 is spherical and coated with nicotine, while the second manipulation member 22 is conical and impregnated with xylitol with a floss string 10 being treated with a mint flavored substance. Further variants are naturally considered within the scope of the present inventive concept.

In addition to net layouts, the device 1 may have alternative layouts, such as an array layout illustrated in FIGS. 1 and 4 having a desirable number of manipulation members. According to another embodiment, the manipulation members 21, 22, 23 are arranged in a loop layout, wherein the members 21, 22, 23 are provided along an endless loop of floss string 10. For the sake of definition, the manipulation members can be considered to be arranged at specific ends of the floss string 10. However, since a loop layout is possible, the end of the floss string is not necessarily the terminal end of the string. Accordingly in this context, the end of the floss string refers merely to the fixing point of the manipulation member.

The dental floss device 1 is preferably packed in a sterile packaging, wherefrom it can be dispensed directly to the user's oral cavity without involving fingers. As the floss string 10 and manipulation members 21 are dimensioned so that the entire device 1 can fit into the oral cavity, only little waste is generated. Once inserted, the device 1 is used by exercising the tongue to move the manipulation members 21 for guiding and tensioning the floss string 10. The flossing action may be enhanced by flexing the cheek and lip muscles. When using a device according to the embodiment of FIG. 1, oral muscles, especially the tongue, is used to position the first and second manipulation members 21, 22 on opposite sides of a group of teeth, whereby the floss string 10 is arranged between adjacent teeth. The floss string 10 is then subjected to flossing motion by moving the manipulation members 21, 22, whereby food residues and plaque are removed from between the teeth. After use the device 1 is disposed of by throwing away or, according to the embodiment involving digestive materials, swallowed.

The inventive flossing concept of the present invention provides also a flossing method, wherein the device is inserted entirely into the oral cavity of the user, whereby the floss string is guided by moving manipulation members only with the oral muscles, such as the tongue, of the user. In particularly, the preferable device suitable for the described method is defined in the accompanying claims.

TABLE 1
List of reference numbers.

| Number | Part |
|---|---|
| 1 | dental flossing device |
| 10 | floss string |
| 11 | first end of the floss string |
| 12 | second end of the floss string |
| 21 | first manipulation member |
| 22 | second manipulation member |
| 23 | third manipulation member |
| 24 | fourth manipulation member |
| 25 | fifth manipulation member |
| 26 | sixth manipulation member |

1. A dental floss device being configured to be inserted entirely into an oral cavity of the user, the device comprising:
a floss string, and
at least one manipulation member attached to the string for control thereof,
wherein the device comprises at least two manipulation members, which are connected by the floss string, wherein the manipulation members are adapted to be guided by oral muscles of the user,
whereby the floss string may be guided by tongue with aid of the manipulation members without introducing fingers to said oral cavity.

2. A dental floss device of claim 1, wherein the device comprises two manipulation members attached to opposite ends of a single floss string.

3. A dental floss device according to claim 1, wherein the manipulation members are spherical.

4. A dental floss device according to claim 1, wherein the manipulation member has a diameter of 3 to 25 mm.

5. A dental floss device according to claim 3, wherein the manipulation member has a diameter of 6 to 12 mm.

6. A dental floss device according to claim 1, wherein the floss string has a span length between the members of 10 to 50 mm.

7. A dental floss device according to claim 1, wherein the floss string has a span length between the members of 15 to 25 mm.

8. A dental floss device according to claim 1, wherein the dental floss device is arranged as a finite band.

9. A dental floss device according to claim 1, wherein the dental floss device being arranged as a loop.

10. A dental floss device according to claim 1, wherein the dental floss device being arranged as a net.

11. A dental floss device according to claim 1, wherein manipulation members are manufactured from a decomposing material, such as natural fiber composite.

12. A dental floss device according to claim 1, wherein the manipulation members or floss string or both are provided with odontological substances, such as fluorine or xylitol, for further hygienic enhancement.

13. A dental floss device according to claim 1, wherein the manipulation members or floss string or both are provided with pharmaceutical substances, such as nicotine or caffeine, for additional medical effect.

14. A dental floss device according to claim 1, wherein the floss string is cast-in into the manipulation member by injection molding.

15. (canceled)

16. (canceled)

17. A dental floss device according to claim 2, wherein the manipulation members are spherical.

18. A dental floss device according to claim 2, wherein the manipulation member has a diameter of 3 to 25 mm.

19. A dental floss device according to claim 3, wherein the manipulation member has a diameter of 3 to 25 mm.

20. A dental floss device according to claim 2, wherein the manipulation member has a diameter of 6 to 12 mm.

21. A dental floss device according to claim 4, wherein the floss string has a span length between the members of 10 to 50 mm.

22. A dental floss device according to claim 4, wherein the floss string has a span length between the members of 15 to 25 mm.

23. A dental floss device according to claim 11, wherein the manipulation members or floss string or both are provided with odontological substances, such as fluorine or xylitol, for further hygienic enhancement.

24. A dental floss device according to claim 11, wherein the manipulation members or floss string or both are provided with pharmaceutical substances, such as nicotine or caffeine, for additional medical effect.

25. A dental floss device according to claim 12, wherein the manipulation members or floss string or both are provided with pharmaceutical substances, such as nicotine or caffeine, for additional medical effect.
